(19) United States
(12) Patent Application Publication
(10) Pub. No.: US 2007/0184383 A1
(43) Pub. Date: Aug. 9, 2007

(54) Photosensitive composition, photosensitive planographic printing plate material, and recording method of planographic printing plate material

(75) Inventor: Taro Konuma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/702,510

(22) Filed: Feb. 6, 2007

(30) Foreign Application Priority Data
Feb. 9, 2006 (JP) JP2006-032202

(51) Int. Cl. G03C 1/00

(52) U.S. Cl. 430/270.1

(57) ABSTRACT

An objective is to provide a photosensitive planographic printing plate material, a photosensitive composition for the photosensitive planographic printing plate material, and a method of recording the planographic printing plate material which are suitable for exposure employing laser light having an emission wavelength of 350-450 nm, and exhibit excellent resistance to chemicals and excellent linearity, together with an excellent safe light property. Also disclosed is a photosensitive composition comprising (A) an addition-polymerizable ethylenic double bond-containing compound that is represented by the following Formula (1), (B) a biimidazole compound that acts as a photopolymerization initiator, (C) a polymer binder, and (D) a dye exhibiting an absorption maximum wavelength of 350-450 nm.

R₍ₘ₋ₙ₎Q[(CH₂C(R₁)(R₂)O)ₐCONH(X₁NHCOO)_{b}X₂(OOCC(R₃)═CH₂)_{C}]ₙ Formula (1)

This application claims priority from Japanese Patent Application No. 2006-032202 filed on Feb. 9, 2006, which is incorporated hereinto by reference.

### TECHNICAL FIELD

The present invention relates to a photosensitive planographic printing plate material employed in a computer-to-plate system (hereinafter referred to as CTP), a photosensitive composition employed in the same, and a method of recording a planographic printing plate employing the above-described photosensitive planographic printing plate material, and specifically to a photosensitive composition suitable for exposure employing laser light having an emission wavelength of 350-450 nm, the photosensitive planographic printing plate material and the method of recording a planographic printing plate, employing the above-described photosensitive planographic printing plate material.

### BACKGROUND

In recent years, in production technologies of printing plates for offset printing, developed and practiced has been CPT which directly records digital image data onto a photosensitive planographic printing plate, employing a laser beam.

Of these, in the printing field, in which a relatively long plate life is demanded, it has been known to employ negative-acting photosensitive planographic printing plate materials having a polymerizable photosensitive layer incorporating polymerizable compounds (refer, for example, to Patent Documents 1 and 2).

Further, known have been printing plate materials which exhibit enhancement of safety for safelight in view of handling of printing plates, and which are applicable to image exposure employing a laser beam having an emission wavelength of 350-450 nm.

Further, high output and downsized blue violet lasers having an emission wavelength of 350-450 nm have been become more readily available on the market. By developing photosensitive planographic printing plates suitable at the above laser wavelengths, room-light handling has been realized (refer, for example, to Patent Documents 3, 4 and 5). Also known is a printing plate material containing biimidazole in a photosensitive layer by which a safe light property is improved under a yellow lamp (refer to Patent Document 6).

However, as to the printing plate material, insufficient printing durability caused by chemicals utilized during printing tends to be generated. A so-called insufficient linearity causes a problem such that the dot size obtained from output data of images is not the same size as on a printing plate. Further, stains at non-image portions are generated during printing, whereby a problem such as insufficient printing performance results.

(Patent Document 1) Japanese Patent O.P.I. Publication No. 1-105238

(Patent Document 2) Japanese Patent O.P.I. Publication No. 2-127404

(Patent Document 3) Japanese Patent O.P.I. Publication No. 2000-35673

(Patent Document 4) Japanese Patent O.P.I. Publication No. 2000-98605

(Patent Document 5) Japanese Patent O.P.I. Publication No. 2001-264978

(Patent Document 6) Japanese Patent O.P.I. Publication No. 2001-194782

### SUMMARY

It is an object of the present invention to provide a photosensitive planographic printing plate material, a photosensitive composition for the photosensitive planographic printing plate material, and a method of recording the planographic printing plate material which are suitable for exposure employing laser light having an emission wavelength of 350-450 nm, and exhibit excellent resistance to chemicals and excellent linearity, together with an excellent safe light property. Disclosed is a photosensitive composition comprising (A) an addition-polymerizable ethylenic double bond-containing compound that is represented by the following Formula (1); (B) a biimidazole compound that acts as a photopolymerization initiator; (C) a polymer binder; and (D) a dye exhibiting an absorption maximum wavelength of 350-450 nm.

R₍ₘ₋ₙ₎Q[(CH₂C(R₁)(R₂)O)ₐCONH(X₁NHCOO)_{b}X₂(OOCC(R₃)═CH₂)_{C}]ₙ Formula (1)

where R represents an alkyl group, a hydroxyalkyl group or an aryl group; R₁ and R₂ each represent a hydrogen atom, an alkyl group or an alkoxyalkyl group; R₃ represents a hydrogen atom, a methyl group or an ethyl group; X₁ represents an aromatic hydrocarbon group having 6-24 carbon atoms or an alkyl group containing an aromatic hydrocarbon group having 6-24 carbon atoms; X₂ represents a saturated hydrocarbon group having 2-8 carbon atoms; Q represents

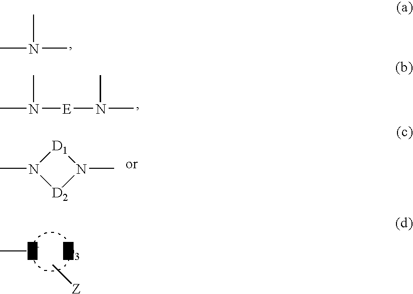

; D₁ and D₂ represent a saturated hydrocarbon group having 1-12 carbon atoms; D₃ represents a saturated hydrocarbon group having 4-8 carbon atoms that forms a 5- to 6-member ring with a nitrogen atom; E represents a saturated hydrocarbon group having 1-12 carbon atoms; Z represents a hydrogen atom, a saturated hydrocarbon group having 1-3 carbon atoms or a —CₖH₂ₖO—CONH(X₁—NHCOO)_{b}—X₂(—OOC—C(R₃)═CH₂) group; a is an integer of 0-4, b is 0 or 1; k is an integer of 1-12; m is 2, 3 or 4; n is an integer of 1-m; and c is 1 or 2.

### DESCRIPTION OF THE PREFERRED EMBODIMENTS

The above object of the present invention is accomplished by the following structures.

(Structure 1) A photosensitive composition comprising (A) an addition-polymerizable ethylenic double bond-containing compound that is represented by the following Formula (1); (B) a biimidazole compound that acts as a photopolymerization initiator; (C) a polymer binder; and (D) a dye exhibiting an absorption maximum wavelength of 350-450 nm.

R₍ₘ₋ₙ₎Q[(CH₂C(R₁)(R₂)O)ₐCONH(X₁NHCOO)_{b}X₂(OOCC(R₃)═CH₂)_{C}]ₙ Formula (1)

where R represents an alkyl group, a hydroxyalkyl group or an aryl group; R₁ and R₂ each represent a hydrogen atom, an alkyl group or an alkoxyalkyl group; R₃ represents a hydrogen atom, a methyl group or an ethyl group, X₁ represents an aromatic hydrocarbon group having 6-24 carbon atoms or an alkyl group containing an aromatic hydrocarbon group having 6-24 carbon atoms; X₂ represents a saturated hydrocarbon group having 2-8 carbon atoms; Q represents

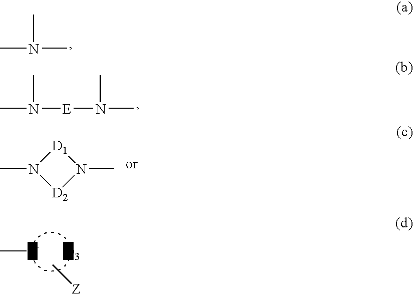

; D₁ and D₂ represent a saturated hydrocarbon group having 1-12 carbon atoms; D₃ represents a saturated hydrocarbon group having 4-8 carbon atoms that forms a 5- to 6-member ring with a nitrogen atom; E represents a saturated hydrocarbon group having 1-12 carbon atoms; Z represents a hydrogen atom, a saturated hydrocarbon group having 1-3 carbon atoms or a —CₖH₂ₖO—CONH(X₁—NHCOO)_{b}—X₂(—OOC—C(R₃)═CH₂) group; a is an integer of 0-4; b is 0 or 1; k is an integer of 1-12; m is 2, 3 or 4; n is an integer of 1-m; and c is 1 or 2.

(Structure 2) The photosensitive composition of Structure 1, further comprising a hydrogen-donating compound.

(Structure 3) The photosensitive composition of Structure 2, wherein the hydrogen-donating compound is a sulfur-containing compound.

(Structure 4) A photosensitive planographic printing plate material comprising a support and provided thereon, a photosensitive layer comprising the photosensitive composition of any one of Structures 1-3.

(Structure 5) A method of recording the photosensitive planographic printing plate material of Structure 4, comprising the step of exposing the photosensitive planographic printing plate material to laser light having an emission wavelength of 350-450 nm as a recording light source to record an image.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

Next, the preferred embodiments of the present invention will be explained below, but the present invention is not limited thereto.

It is a feature in the present invention that a photosensitive composition comprises (A) an addition-polymerizable ethylenic double bond-containing compound that is represented by the following Formula (1); (B) a biimidazole compound that acts as a photopolymerization initiator; (C) a polymer binder; and (D) a dye exhibiting an absorption maximum wavelength of 350-450 nm.

In the present invention, a photosensitive planographic printing plate material exhibiting excellent resistance to chemicals, linearity and printing performance can be provided by utilizing a photosensitive layer specifically containing a biimidazole compound and the above-described polymerizable compound in combination.

Each of compositions contained in a photosensitive composition of the present invention will be described. [(A) Addition-polymerizable ethylenic double bond-containing compound (hereinafter also referred to simply as (A))]

The (A) addition-polymerizable ethylenic double bond-containing compound of the present invention is a compound having an ethylenic double bond capable of polymerizing via imagewise exposure, and the photosensitive composition of the present invention contains a compound represented by Formula (1) as (A).

In Formula (1), R represents an alkyl group, a hydroxyalkyl group or an aryl group.

Examples of the alkyl group include a methyl group, an ethyl group, a propyl group, a butyl group and so forth. Examples of the hydroxyalkyl group include a hydroxymethyl group, a hydroxyethyl group and so forth. Examples of the aryl group include a phenyl group, a naphthyl group and so forth.

R₁ and R₂ each represent a hydrogen atom, an alkyl group or an alkoxyalkyl group, and R₃ represents a hydrogen atom, a methyl group or an ethyl group.

X₁ represents an aromatic hydrocarbon group having 6-24 carbon atoms or an alkyl group having an aromatic hydrocarbon group, and X₂ represents a saturated hydrocarbon group having 2-8 carbon atoms. Examples of X₁ include a tolyl group, a xylene group, an alkyldiphenyl group, a naphthalene group and so forth.

Q represents a nitrogen-containing group as shown above. D₁ and D₂ represent a saturated hydrocarbon group having 1-12 carbon atoms, and D₃ represents a saturated hydrocarbon group having 4-8 carbon atoms that forms a 5- to 6-member ring with a nitrogen atom. D₃ may form a 5- to 6-member ring with a plurality of nitrogen atoms. E represents a saturated hydrocarbon group having 1-12 carbon atoms. E may form a ring with N. In the case of forming a ring with N, (b) of Q is trivalent or divalent. Z represents a hydrogen atom, a saturated hydrocarbon group having 1-3 carbon atoms or a —CₖH₂ₖO—CONH(X₁—NHCOO)_{b}—X₂(—OOC—C(R₃)═CH₂) group. Symbol a is an integer of 0-4; b is 0 or 1; k is an integer of 1-12; m is 2, 3 or 4; n is an integer of 1-m; and c is 1 or 2.

Examples of Q, R, R₁, R₂, a X₁, X₂, k, b, R₃ and n, and examples of the compound represented by Formula (1) will be shown below.

| Com- | | | | | | | | | | | |
|---|---|---|---|---|---|---|---|---|---|---|---|
| pound | | | | | | | | | | | |
| No. | Q | R | R₁ | R₂ | a | X₁ | X₂ | k | b | R₃ | n |
| 1 | 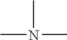 | CH₃(CH₂)— | H | H | 1 | 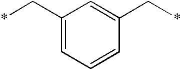 | —CH₂CH₂— | — | 1 | CH₃ | 2 |
| 2 | 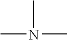 | CH₃(CH₂)₃— | H | H | 1 | 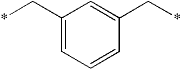 | —CH₂CH₂— | — | 1 | CH₃ | 2 |
| 3 | 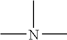 | CH₃(CH₂)₃— | H— | H— | 10 | 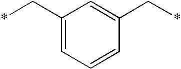 | —CH₂CH₂——CH₂CH₂— | —— | 11 | CH₃CH₃ | 2 |
| 4 | 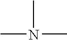 | CH₃(CH₂)₁₁—— | H— | H— | 10 | 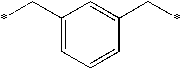 | —CH₂CH₂——CH₂CH₂— | —— | 11 | CH₃CH₃ | 2 |
| 5 | 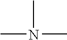 | — | H | H | 1 | 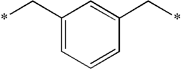 | —CH₂CH₂— | — | 1 | CH₃ | 3 |
| 6 | 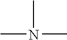 | — | H | H | 1 | 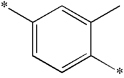 | —CH₂CH₂— | — | 1 | CH₃ | 3 |
| 7 | 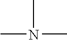 | — | H | H | 1 | 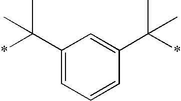 | —CH₂CH₂— | — | 1 | CH₃ | 3 |
| 8 | 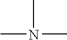 | C₆H₅— | H | H | 1 | 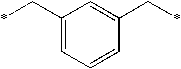 | —CH₂CH₂— | — | 1 | CH₃ | 2 |
| 9 | 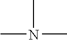 | CH₃(CH₂)₃— | H | H | 1 | 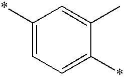 | —CH₂CH₂— | — | 1 | CH₃ | 2 |
| 10 | 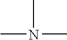 | CH₃(CH₂)₃— | H | H | 1 | 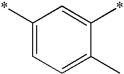 | —CH₂CH₂— | — | 1 | CH₃ | 2 |
| 11 | 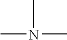 | CH₃(CH₂)₃— | H | H | 1 | 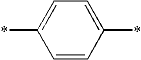 | —CH₂CH₂— | — | 1 | CH₃ | 2 |
| 12 | 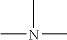 | CH₃(CH₂)₃— | H | H | 1 | 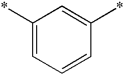 | —CH₂CH₂— | — | 1 | CH₃ | 2 |
| 13 | 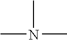 | CH₃(CH₂)₃— | H | H | 1 | 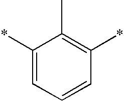 | —CH₂CH₂— | — | 1 | CH₃ | 2 |
| 14 | 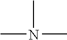 | CH₃(CH₂)₃— | H | H | 1 | 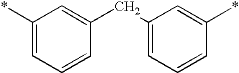 | —CH₂CH₂— | — | 1 | CH₃ | 2 |
| 15 | 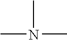 | CH₃(CH₂)₃— | H | H | 1 | 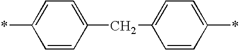 | —CH₂CH₂— | — | 1 | CH₃ | 2 |
| 16 | 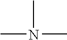 | CH₃(CH₂)₃— | H | H | 1 | 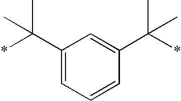 | —CH₂CH₂— | — | 1 | CH₃ | 2 |
| 17 | 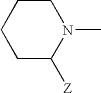 | — | — | — | 0 | 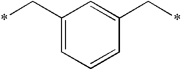 | —CH₂CH₂— | 2 | 1 | CH₃ | 1 |
| 18 | 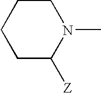 | — | — | — | 0 | 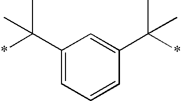 | —CH₂CH₂— | 2 | 1 | CH₃ | 1 |
| 19 | 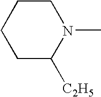 | — | — | — | 0 | 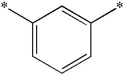 | —CH₂CH₂— | — | 1 | CH₃ | 1 |
| 20 | 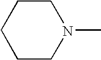 | — | — | — | 0 | 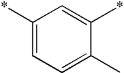 | —CH₂CH₂— | — | 1 | CH₃ | 1 |
| 21 | 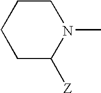 | — | — | — | 0 | 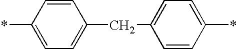 | —CH₂CH₂— | 2 | 1 | CH₃ | 1 |
| 22 | 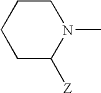 | — | — | — | 0 | 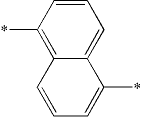 | —CH₂CH₂— | 2 | 1 | CH₃ | 1 |
| 23 | 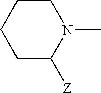 | — | — | — | 0 | 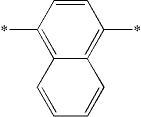 | —CH₂CH₂— | 2 | 1 | CH₃ | 1 |
| 24 | 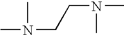 | — | H | H | 1 | 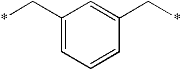 | —CH₂CH₂— | — | 1 | CH₃ | 4 |
| 25 | 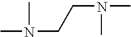 | — | CH₃ | H | 1 | 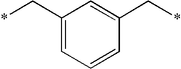 | —CH₂CH₂— | — | 1 | CH₃ | 4 |
| 26 | 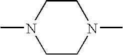 | — | H | H | 1 | 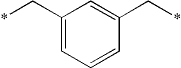 | —CH₂CH₂— | — | 1 | CH₃ | 2 |
| 27 | 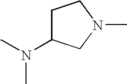 | CH₃ | — | — | 0 | 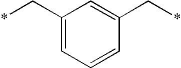 | —CH₂CH₂— | — | 1 | CH₃ | 2 |
| 28 | 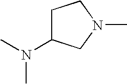 | — | — | — | 0 | 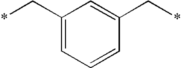 | —CH₂CH₂— | — | 1 | CH₃ | 3 |
| 29 | 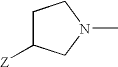 | — | H | H | 0 | 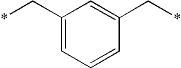 | —CH₂CH₂— | 2 | 1 | CH₃ | 1 |
| 30 | 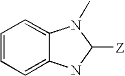 | — | H | H | 0 | 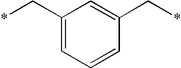 | —CH₂CH₂— | 2 | 1 | CH₃ | 1 |
| 31 | 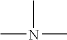 | CH₃(CH₂)₃— | H | H | 1 | 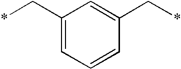 | CH(CH₃)CH₂— | — | 1 | CH₃ | 2 |
| 32 | 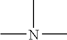 | CH₃(CH₂)₃— | H | H | 1 | 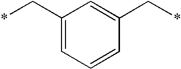 | —(CH₂)₄— | — | 1 | CH₃ | 2 |
| 33 | 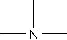 | CH₃(CH₂)₃— | H | H | 1 | 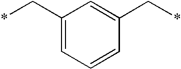 | —CH(CH₃)CH₂CH₂— | — | 1 | CH₃ | 2 |
| 34 | 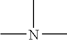 | CH₃(CH₂)₃— | H | H | 1 | 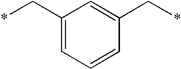 | —CH(CH₃)CH₂— | — | 1 | H | 2 |

As for the above compound No. 2, a compound in which R is a hydroxyethyl group, a compound in which a is 4 and a compound in which b is 0, and as for the above compound No. 17, a compound in which k is 12 are also provided. In addition, c in examples of the above-described compound is 1.

The content of a compound represented by Formula (1) is preferably 30-80% by weight, based on the weight of the photosensitive layer, and more preferably 35-65% by weight.

A photosensitive composition of the present invention may be used in combination with a compound other than a compound represented by Formula (1) as an addition-polymerizable ethylenic double bond-containing compound.

Examples of the ethylenically unsaturated compound usable in combination include conventional radically polymerizable monomers, and polyfunctional monomers and polyfunctional oligomers each having plural ethylenically unsaturated bond ordinarily used in UV-curable resins. The ethylenically unsaturated compound is not specifically limited, but preferred examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryloxyethyl acrylate, tetrahydrofurfuryloxyhexyl acrylate, or 1,3-dioxolanyl acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate, hydroxypivalylaldehyde modified dimethylolpropane triacrylate or EO-modified products thereof; and a methacrylate, itaconate, crotonate or maleate alternative of the above polyfunctional acrylate.

A prepolymer can be used as the ethylenically unsaturated compound described above. Examples of the prepolymer include compounds described later and prepolymers with a photopolymerization property obtained by incorporating an acryloyl or methacryloyl group into a prepolymer with an appropriate molecular weight. These prepolymers can be used singly or as an admixture of the above described monomers and/or oligomers.

Examples of the prepolymer include polyester (meth)acrylate obtained by incorporating (meth)acrylic acid in a polyester of a polybasic acid such as adipic acid, trimellitic acid, maleic acid, phthalic acid, terephthalic acid, hymic acid, malonic acid, succinic acid, glutaric acid, itaconic acid, pyromellitic acid, fumalic acid, pimelic acid, sebatic acid, dodecanic acid or tetrahydrophthalic acid with a polyol such as ethylene glycol, ethylene glycol, diethylene glycol, propylene oxide, 1,4-butane diol, triethylene glycol, tetraethylene glycol, polyethylene glycol, grycerin, trimethylol propane, pentaerythritol, sorbitol, 1,6-hexanediol or 1,2,6-hexanetriol; an epoxyacrylate such as bisphenol A.epichlorhydrin.(meth)acrylic acid or phenol novolak.epichlorhydrin.(meth)acrylic acid obtained by incorporating (meth)acrylic acid in an epoxy resin; an urethaneacrylate such as ethylene glycol-adipic acid.tolylenediisocyanate.2-hydroxyethylacrylate, polyethylene glycol.tolylenediisocyanate.2-hydroxyethylacrylate, hydroxyethylphthalyl methacrylate.xylenediisocyanate, 1,2-polybutadieneglycol.tolylenediisocyanate.2-hydroxyethylacrylate or trimethylolpropane.propylene glycol.tolylenediisocyanate.2-hydroxyethylacrylate, obtained by incorporating (meth)acrylic acid in an urethane resin; a silicone acrylate such as polysiloxane acrylate, or polysiloxane.diisocyanate.2-hydroxyethylacrylate; an alkyd modified acrylate obtained by incorporating a methacroyl group in an oil modified alkyd resin; and a spiran resin acrylate.

The photosensitive composition of the present invention can contain a monomer such as a phosphazene monomer, triethylene glycol, an EO modified isocyanuric acid diacrylate, an EO modified isocyanuric acid triacrylate, dimethyloltricyclodecane diacrylate, trimethylolpropane acrylate benzoate, an alkylene glycol acrylate, or a urethane modified acrylate, or an addition polymerizable oligomer or prepolymer having a structural unit derived from the above monomer.

As the ethylenically unsaturated compound used in combination in the photosensitive layer, there is a phosphate compound having at least one (meth)acryloyl group. The phosphate compound is a compound having a (meth)acryloyl group in which at least one hydroxyl group of phosphoric acid is esterified, but is not limited as long as it has a (meth)acryloyl group.

Besides the above compounds, compounds disclosed in Japanese Patent O.P.I. Publication Nos. 58-212994, 61-6649, 62-46688, 62-48589, 62-173295, 62-187092, 63-67189, and 1-244891, compounds described on pages 286 to 294 of “11290 Chemical Compounds” edited by Kagakukogyo Nipposha, and compounds described on pages 11 to 65 of “UV.EB Koka Handbook (Materials)” edited by Kobunshi Kankokai can be suitably used. Of these compounds, compounds having two or more acryl or methacryl groups in the molecule are preferable, and those having a molecular weight of not more than 10,000, and preferably not more than 5,000 are more preferable.

### (Biimidazole Compound)

A biimidazole compound contained as a photopolymerization initiator of the present invention will be described.

The biimidazole compound is a derivative of biimidazole, and examples thereof include those disclosed in for example, Japanese Patent O.P.I. Publication No. 2003-295426.

In the present invention, a hexaarylbisimidazole (HABI, a dimer of a triarylimidazole) compound is preferred as the biimidazole compound.

The synthetic method of the hexaarylbisimidazoles (HABI, dimmers of triarylimidazoles) is disclosed in DIELECTRIC 1470154, and use thereof in a photopolymerizable composition is disclosed in EP 24629, EP 107792, U.S. Pat. No. 4,410,621, EP 215453 and DE 321312.

Preferred examples of the biimidazole compound include 2,4,5,2′,4′,5′-hexaphenylbisimidazole, 2,2′-bis(2-chlorophenyl)-4,5,4′,5′-tetraphenylbisimidazole, 2,2′-bis(2-bromophenyl)-4,5,4′,5′-tetraphenylbisimidazole, 2,2′-bis(2,4-dichlorophenyl)-4,5,4′,5′-tetraphenylbisimidazole, 2,2′-bis(2-chlorophenyl)-4,5,4′,5′-tetrakis(3-methoxyphenyl)bisimidazole, 2,2′-bis(2-chlorophenyl)-4,5,4′,5′-tetrakis(3,4,5-trimethoxyphenyl)bisimidazole, 2,5,2′,5′-tetrakis(2-chlorophenyl)-4,4′-bis(3,4-dimethoxyphenyl)bisimidazole, 2,2′-bis(2,6-dichlorophenyl)-4,5,4′,5′-tetraphenylbisimidazole, 2,2′-bis(2-nitrophenyl)-4,5,4′,5′-tetraphenylbisimidazole, 2,2′-di-o-tolyl-4,5,4′,5′-tetraphenylbisimidazole, 2,2′-bis(2-ethoxyphenyl)-4,5,4′,5′-tetraphenylbisimidazole, and 2,2′-bis(2,6-difluorophenyl)-4,5,4′,5′-tetraphenylbisimidazole.

The content of HABI photopolymerization intiator is typically 0.01-30% by weight, based on the total weight of the non-volatile composition in the photosensitive composition, and preferably 0.5-20% by weight.

The content of a biimidazole compound is preferably 0.5-15% by weight, based on the weight of a compound represented by Formula (1), and more preferably 1.5-8.0% by weight.

A photosensitive composition of the present invention may contain the following iron arene complex compounds and other photopolymerization initiators as the photopolymerization initiator.

### (Iron Arene Complex Compound)

The iron arene complex compound used in the invention is a compound represented by Formula (a) below.

### Formula (a)

(A-Fe—B)⁺X⁻ Formula (a)

wherein A represents a substituted or unsubstituted cyclopentadienyl group or a substituted or unsubstituted cyclohexadienyl group; B represents a compound having an aromatic ring; and X⁻ is an anion.

Examples of the compound having an aromatic ring include benzene, toluene, xylene, cumene, naphthalene, 1-methylnaphtalene, 2-methylnaphtalene, biphenyl, fluorene, anthracene and pyrene. Examples of X⁻ include PF₆⁻, BF₄⁻, SbF₆⁻, AlF₄⁻, and CF₃SO₃⁻. The substituents of the substituted or unsubstituted cyclopentadienyl group or a substituted or unsubstituted cyclohexadienyl group include an alkyl group such as methyl, ethyl, etc., a cyano group, an acetyl group and a halogen atom.

The content of an iron arene complex compound, based on a compound having a polymerizable group is preferably 0.1-20% by weight, and more preferably 0.1-10% by weight.

Examples of the iron arene complex compound include:

### Fe-1: (η⁶-benzene) (η⁵-cyclopentadienyl)iron (II) hexafluorophosphate;

### Fe-2: (η⁶-toluene) (η⁵-cyclopentadienyl)iron (II) hexafluorophosphate;

### Fe-3: (η⁶-cumene) (η⁵-cyclopentadienyl)iron (II) hexafluorophosphate;

### Fe-4: (η⁶-benzene) (η⁵-cyclopentadienyl)iron (II) hexafluoroarsenate;

### Fe-6: (η⁶-benzene) (η⁵-cyclopentadienyl)iron (II) tetrafluoroborate;

### Fe-6: (η⁶-naphthalene)(η⁵-cyclopentadienyl)iron (II) hexafluorophosphate;

### Fe-7: (η⁶-anthracene)(η⁵-cyclopentadienyl)iron (II) hexafluorophosphate;

### Fe-8: (η⁶-pyrene)(η⁵-cyclopentadienyl)iron (II) hexafluorophosphate;

### Fe-9: (η⁶-benzene) (η⁵-cyanocyclopentadienyl)iron (II) hexafluorophosphate;

### Fe-10: (η⁶-toluene)(η⁵-acetylcyclopentadienyl)iron (II) hexafluorophosphate;

### Fe-11: (η⁶-cumene)(η⁵-cyclopentadienyl)iron (II) tetrafluoroborate;

### Fe-12: (η⁶-benzene) (η⁵-carboethoxycyclohexadienyl)iron (II) hexafluorophosphate;

### Fe-13: (η⁶-benzene) (η⁵-1,3-dichlorocyclohexadienyl)iron (II) hexafluorophosphate;

### Fe-14: (η⁶-cyanobenzene)(η⁵-cyclohexadienyl)iron (II) hexafluorophosphate;

### Fe-15: (η⁶-acetophenone) (η⁵-cyclohexadienyl)iron (II) hexafluorophosphate;

### Fe-16: (η⁶-methyl benzoate)(η⁵-cyclopentadienyl)iron (II) hexafluorophosphate;

### Fe-17: (η⁶-benzene sulfonamide) (η⁵-cyclopentadienyl)iron (II) tetrafluoroborate;

### Fe-18: (η⁶-benzamide) (η⁵-cyclopentadienyl)iron (II) hexafluorophosphate;

### Fe-19: (η⁶-cyanobenzene)(η⁵-cyanocyclopentadienyl)iron (II) hexafluorophosphate;

### Fe-20: (η⁶-chloronaphthalene)(η⁵-cyclopentadienyl)iron (II) hexafluorophosphate;

### Fe-21: (η⁶-anthracene)(η⁵-cyanocyclopentadienyl)iron (II) hexafluorophosphate;

### Fe-22: (η⁶-chlorobenzene)(η⁵-cyclopentadienyl)iron (II) hexafluorophosphate; and

### Fe-23: (η⁶-chlorobenzene)(η⁵-cyclopentadienyl)iron (II) tetrafluoroborate.

These compounds can be synthesized according to a method described in Dokl. Akd. Nauk. SSSR 149 615 (1963).

In the present invention, examples of the commonly known photopolymerization initiator include aromatic ketones, aromatic onium salts, organic peroxide, a thio compound, a ketoxime ester compound, a borate compound, an azinium compound, a metallocene compound, an active ester compound, a polyhalogen compound having carbon-halogen bond and so forth, and these are usable in compositions of the present invention in combination.

The photosensitive composition of the present invention preferably contains a hydrogen-donating compound in view of improved sensitivity.

The hydrogen-donating compound itself becomes a radical by giving a hydrogen to an imidazole radical generated via splitting of biimidazole, and is a compound exhibiting radically polymerizable initiator capability. Specifically, a sulfur-containing compound is preferably usable as the hydrogen-donating compound.

Examples of this sulfur-containing compound include an alkylthiol derivative, a hydroxylalkylthiol derivative, a mercaptobenzothiozole derivative, a mercaptobenziimidazole derivative, a mercaptobenzoxazole derivative, mercaptotriazole derivative and a mercaptotetrazole compound.

The compound represented by following Formula (2) is preferably usable as the sulfur-containing compound.

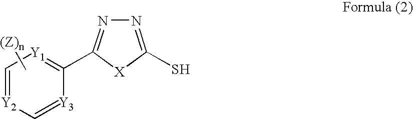

In Formula (2), X represents a sulfur atom, a nitrogen atom or an oxygen atom. However, in the case of the nitrogen atom, X represents NH. Y₁, Y₂ and Y₃ each represent a nitrogen atom or a carbon atom. Z is a hydrogen atom, an alkyl group which may comprise a substituent, or an alkoxy group which may comprise a substituent. Symbol n is an integer of 0-5.

Examples of the compound represented by Formula (2) are shown below.

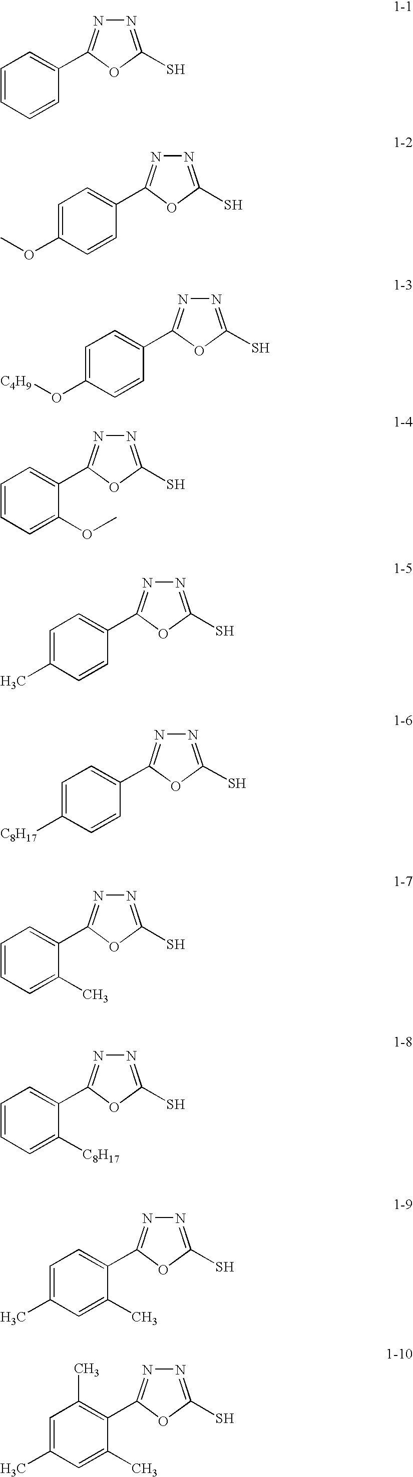

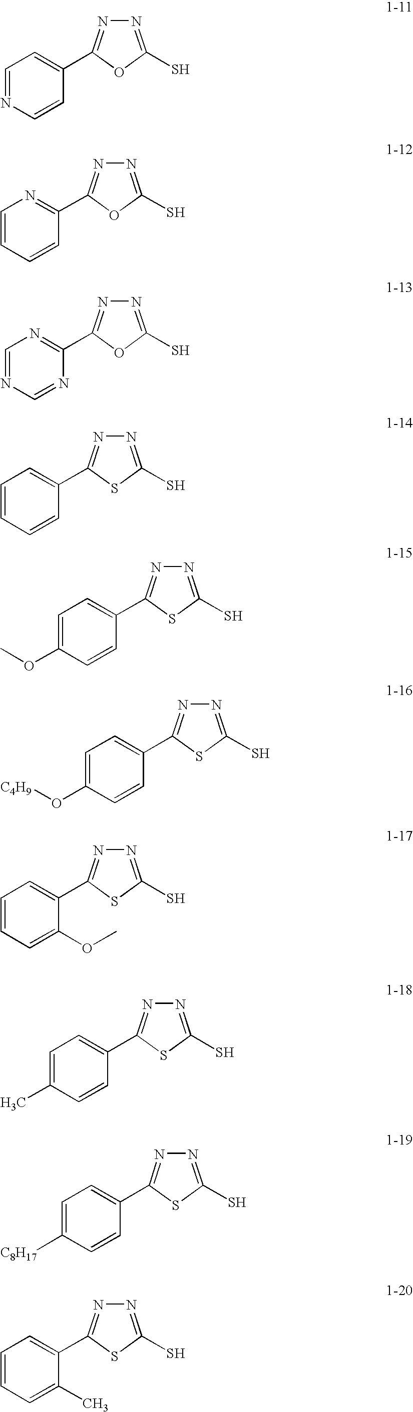

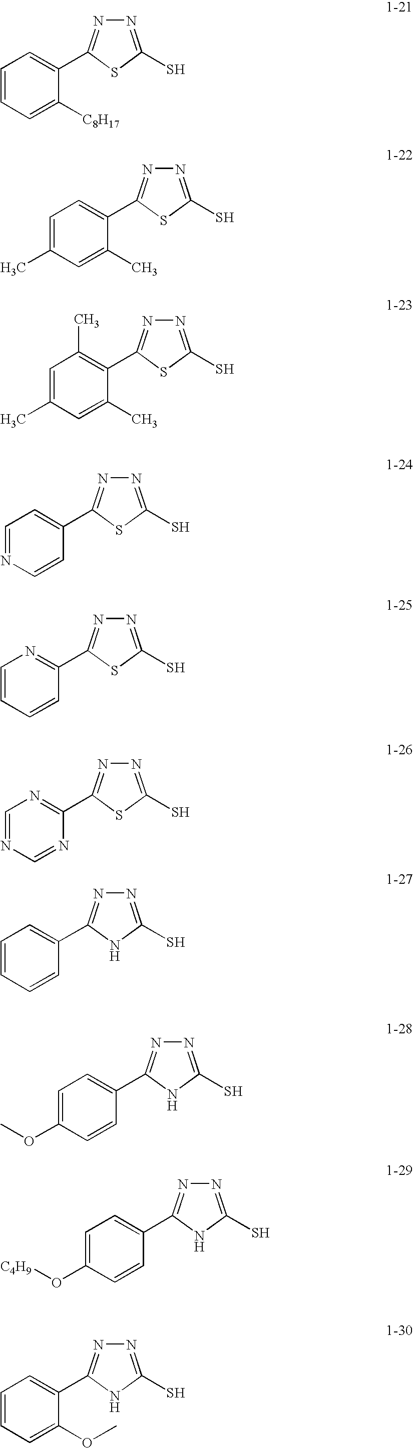

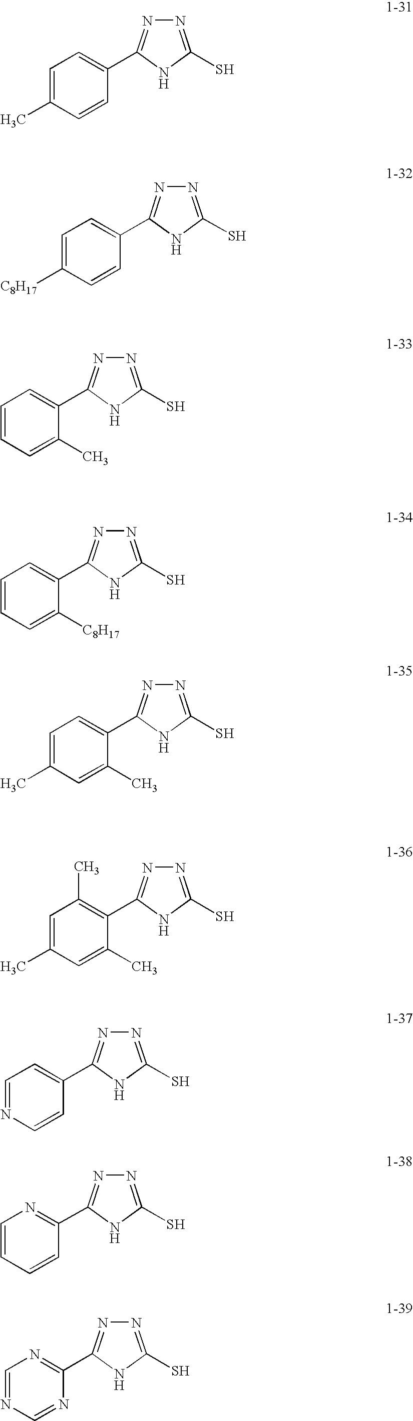

The content of a compound represented by Formula (2) is preferably 0.1-2.5% by weight, based on the weight of the photosensitive layer, and more preferably 0.15-1.0% by weight. The content of a compound represented by Formula (2) is also preferably 0.1-2.5% by weight, based on the weight of a compound represented by Formula (1), and more preferably 0.15-0.8% by weight.

### (Polymer Binder)

Next, polymer binder will be described.

Examples of the polymer binder usable in the present invention include an acrylic polymer, a polyvinylbutyral resin, a polyurethane resin, a polyamide resin, a polyester resin, an epoxy resin, a phenol resin, a polycarbonate resin, a polyvinylformal and others such as a natural resin and the like. These are also used in combination with at least two kinds.

A vinyl based copolymer prepared via copolymerization of acrylic monmers is preferable. Further, a copolymer of (a) carboxyl group-containing monomer and (b) a copolymer of alkylester methacrylate or alkylester acrylate is preferable as a copolymeric composition of the polymer binder.

Examples of the carboxyl group-containing monomer include an α,β-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl ester such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

Monomers described in the following items (1)-(14) can further be utilized as another copolimerizable monomer for the polymer binder in the present invention.

1) A monomer having an aromatic hydroxy group, for example, o-, (p- or m-) hydroxystyrene, or o-, (p- or m-) hydroxyphenylacrylate.

2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether.

3) A monomer having an aminosulfonyl group, for example, m- or p-aminosulfonylphenyl methacrylate, m- or p-aminosulfonylphenyl acrylate, N-(p-aminosulfonylphenyl) methacrylamide, or N-(p-aminosulfonylphenyl)acrylamide.

4) A monomer having a sulfonamido group, for example, N-(p-toluenesulfonyl)acrylamide, or N-(p-toluenesulfonyl)-methacrylamide.

5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide.

6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide.

7) A vinyl ether, for example, ethyl vinyl ether, 2-chloroethyl vinyl ether, propyl vinyl ether, butyl vinyl ether, octyl vinyl ether, or phenyl vinyl ether.

8) A vinyl ester, for example, vinyl acetate, vinyl chroloacetate, vinyl butyrate, or vinyl benzoate.

9) A styrene, for example, styrene, methylstyrene, or chloromethystyrene.

10) A vinyl ketone, for example, methyl vinyl ketone, ethyl vinyl ketone, propyl vinyl ketone, or phenyl vinyl ketone.

11) An olefin, for example, ethylene, propylene, isobutylene, butadiene, or isoprene.

12) N-vinylpyrrolidone, N-vinylcarbazole, or N-vinylpyridine.

13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene.

14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further, another monomer may be copolymerized with the above monomer.

The above vinyl polymer can be manufactured according to a conventional solution polymerization, bulk polymerization or suspension polymerization. A polymerization initiator used is not specifically limited, but examples thereof include azo bis type radical generating agents, for example, 2,2′-azobisiso-butyronitrile (AIBN) or 2,2′-azobis(2-methylbutyronitrile). The amount used of the polymerization initiator is ordinarily from 0.05 to 10.0 parts by weight (preferably from 0.1 to 5 parts by weight), based on 100 parts by weight of monomer as a whole employed to prepare a (co)polymer. As the solvents used in the solution polymerization, there are organic solvents including ketones, esters or aromatics, for example, good solvents generally used in the solution polymerization such as toluene, ethyl acetate, benzene, methylcellosolve, ethylcellosolve, acetone, and methyl ethyl ketone. Among these, ones having a boiling point of from 60 to 120° C. are preferred. The solution polymerization is ordinarily carried out at 40 to 120° C. (preferably 60 to 110° C.), for 3 to 10 hours (preferably 5 to 8 hours) employing the above solvents. After completion of polymerization, the solvents are removed from the resulting polymerization solution to obtain a copolymer. Alternatively, the polymerization solution is used without removing the solvents in a double bond incorporation reaction as described later which follows.

The molecular weight of the resulting copolymer can be adjusted by selecting solvents used or by controlling polymerization temperature. The solvents used or the polymerization temperature for obtaining a polymer with an intended molecular weight is appropriately determined by monomers used. The molecular weight of the polymer can be also adjusted by mixing the above solvents with a specific solvent. Examples of the specific solvent include mercaptans such as n-octylmercaptan, n-dodecylmercaptan, t-dodecylmercaptan and mercaptoethanol, and carbon chlorides such as carbon tetrachloride, butyl chloride and propylene chloride. The mixing ratio of the specific solvent to the solvents described above can be properly determined by monomers used, solvents used or polymerization conditions.

The polymer binder in the present invention is preferably a vinyl polymer having in the side chain a carboxyl group and a polymerizable double bond. As the polymer binder is also preferred an unsaturated bond-containing vinyl copolymer which is obtained by reacting a carboxyl group contained in the above vinyl copolymer molecule with for example, a compound having a (meth)acryloyl group and an epoxy group.

Examples of the compound having a (meth)acryloyl group and an epoxy group in the molecule include glycidyl acrylate, glycidyl methacrylate and an epoxy group-containing unsaturated compound disclosed in Japanese Patent O.P.I. Publication No. 11-27196. Further, an unsaturated bond-containing copolymer which is obtained by reacting a hydroxyl group contained in the above vinyl copolymer molecule with for example, a compound having a (meth)acryloyl group and an isocyanate group. Examples of the compound having a (meth)acryloyl group and an isocyanate group in the molecule include vinyl isocyanate, (meth)acryl isocyanate, 2-(meth)acroyloxyethyl isocyanate, m- or p-isopropenyl-α,α′-dimethylbenzyl isocyanate, and (meth)acryl isocyanate, or 2-(meth)acroyloxyethyl isocyanate is preferred.

Reaction of a carboxyl group existing in the molecule of the vinyl copolymer with a compound having in the molecule a (meth)acryloyl group and an epoxy group can be carried out according to a well-known method. For example, the reaction is carried out at a temperature of 20 to 100° C., and preferably 40 to 80° C., and more preferably at a boiling point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an aliphatic epoxy group-containing unsaturated compound is incorporated into the vinyl copolymer. The reaction can be carried out in the presence of a catalyst or a polymerization inhibitor.

As the catalyst, there are amines or ammonium chlorides. Examples of the amines include triethylamine, tributylamine, dimethylaminoethanol, diethylaminoethanol, methylamine, ethylamine, n-propylamine, i-propylamine, 3-methoxypropylamine, butylamine, allylamine, hexylamine, 2-ethylhexylamine, and benzylamine. Examples of the ammonium chlorides include triethylbenzylammonium chloride.

The amount used of the catalyst is ordinarily from 0.01 to 20.0% by weight based on the weight of an aliphatic epoxy group-containing unsaturated compound used. Examples of the polymerization inhibitor include hydroquinone, hydroquinone monometyl ether, 2,5-di-t-butylhydroquinone, 2,6-di-t-butylhydroquinone, 2-methylhydroquinone, and 2-t-butylhydroquinone. The amount used of the polymerization inhibitor is ordinarily from 0.01 to 5.0% by weight based on the weight of aliphatic epoxy group-containing unsaturated compound used. The reaction process is controlled by measurement of acid value of the reaction mixture and the reaction is terminated at the time when the intended acid value is attained.

Reaction of a hydroxyl group existing in the molecule of the vinyl copolymer with a compound having in the molecule a (meth)acryloyl group and an isocyanate group can be carried out according to a known method. For example, the reaction is carried out at a temperature of 20 to 100° C., and preferably 40 to 80° C., and more preferably at a boiling point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an isocyanate group-containing unsaturated compound is incorporated into the vinyl copolymer. The reaction can be carried out in the presence of a catalyst or a polymerization inhibitor. As the catalyst, tin compounds or amines are preferably used. Examples of thereof include dibutyltin laurate, and triethylamine.

The amount used of the catalyst is preferably from 0.01 to 20.0% by weight based on the weight of a double bond-containing compound used. Examples of the polymerization inhibitor include hydroquinone, hydroquinone monometyl ether, t-butylhydroquinone, 2,5-di-t-butylhydroquinone, methylhydroquinone, p-benzoquinone, methyl-p-benzoquinone, t-butyl-p-benzoquinone, and 2,5-diphenyl-p-benzoquinone. The amount used of the polymerization inhibitor is ordinarily from 0.01 to 5.0% by weight based on the weight of isocyanate group-containing unsaturated compound used. The reaction process is controlled by measurement of infrared absorption spectra (IR) of the reaction mixture and the reaction is terminated at the time when the isocyanate absorption disappears.

The content of the vinyl polymer having in the side chain a carboxyl group and a polymerizable double bond is preferably from 50 to 100% by weight, and more preferably 100% by weight, based on the total weight of the polymer binder used.

The polymer binder content of the photosensitive layer is preferably from 10 to 90% by weight, more preferably from 15 to 70% by weight, and still more preferably from 20 to 50% by weight, in view of sensitivity.

### (Dye Having Absorption Maximum in Wavelength Region of 350-450 nm)

The photosensitive composition of the present invention contains a sensitizing dye having absorption maximum in the wavelength region of 350-450 nm.

Examples of the dyes include cyanine, merocyanine, porphyrin, a spiro compound, ferrocene, fluorene, fulgide, imidazole, perylene, phenazine, phenothiazine, acridine, an azo compound, diphenylmethane, triphenylmethane, triphenylamine, cumarin derivatives, ketocumarin, quinacridone, indigo, styryl, pyrylium compounds, pyrromethene compounds, pyrazolotriazole compounds, benzothiazole compounds, barbituric acid derivatives, thiobarbituric acid derivatives, and ketoalcohol borate complexes.

Of these sensitizing dyes, a coumarin dye represented by following Formula (A) is especially preferred.

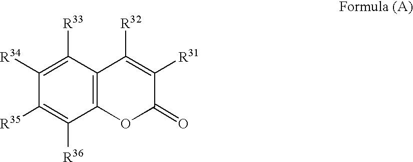

In the above formula, R³¹, R³², R³³, R³⁴, R³⁵ and R³⁶ independently represent a hydrogen atom or a substituent. Examples of the substituent include an alkyl group (for example, a methyl group, an ethyl group, a propyl group, an isopropyl group, a t-butyl group, a pentyl group, a hexyl group, an octyl group, a dodecyl group, a tridecyl group, a tetradecyl group, or a pentadecyl group), a cycloalkyl group (for example, a cyclopentyl group or a cyclohexyl group), an alkenyl group (for example, a vinyl group or a allyl group), an alkinyl group (for example, a propargyl group), an aryl group (for example, a phenyl group, or a naphthyl group), a heteroaryl group (for example, a furyl group, a thienyl group, a pyridazinyl group, a pyrimidinyl group, a pyrazinyl group, a triazinyl group, an imidazolyl group, a pyrazolyl group, a thiazolyl group, a benzimidazolyl group, a benzoxazolyl group, a quinazolyl group, or a phthalazinyl group), a saturated heterocyclic group (for example, a pyrrolidinyl group, an imidazolidinyl group, a morpholinyl group or an oxazolidinyl group), an alkoxy group (for example, a methoxy group, an ethoxy group, a propoxy group, a pentyloxy group, a hexyloxy group, an octyloxy group, or a dodecyloxy group), a cycloalkoxy group (for example, a cyclopentyloxy group, or a cyclohexyloxy group), an aryloxy group (for example, a phenoxy group or a naphthyloxy group), an alkylthio group (for example, a methylthio group, an ethylthio group, a propylthio group, a pentylthio group, a hexylthio group, an octylthio group, or a dodecylthio group), a cycloalkylthio group (for example, a cyclopentylthio group or a cyclohexylthio group), an arylthio group (for example, a phenylthio group, or a naphthylthio group), an alkoxycarbonyl group (for example, a methyloxycarbonyl group, an ethyloxycarbonyl group, a butyloxycarbonyl group, an octyloxycarbonyl group, or a dodecyloxycarbonyl group), an aryloxycarbonyl group (for example, a phenyloxycarbonyl group, or a naphthyloxycarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, or a 2-pyridylaminosulfonyl group), an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecycarbonyl group, a phenylcarbonyl group, a naphthylcarbonyl group, or a pyridylcarbonyl group), an acyloxy group (for example, an acetyloxy group, an ethylcarbonyloxy group, a butylcarbonyloxy group, an octylcarbonyloxy group, a dodecycarbonyloxy group, or a phenylcarbonyloxy group), an amido group (for example, a methylcarbonylamino group, an ethylcarbonylamino group, a dimethylcarbonylamino group, a propylcarbonylamino group, a pentylcarbonylamino group, a cyclohexylcarbonylamino group, 2-ethylhexylcarbonylamino group, an octylcarbonylamino group, a dodecycarbonylamino group, a phenylcarbonylamino group, a naphthylcarbonylamino group, or a pyridylcarbonyl group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecyaminocarbonyl group, a phenylaminocarbonyl group, a naphthylaminocarbonyl group, or a 2-pyridylaminocarbonyl group), a ureido group (for example, a methylureido group, an ethylureido group, a pentylureido group, a cyclohexylureido group, an octylureido group, a dodecylureido group, a phenylureido group, a naphthylureido group, or a 2-pyridylureido group), a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group), an alkylsulfonyl group (for example, a methylsulfonyl group, an ethylsulfonyl group, a butylsulfonyl group, a cyclohexylsulfonyl group, a 2-ethylhexylsulfonyl group, or a dodecylsulfonyl group), an arylsulfonyl group (for example, a phenylsulfonyl group, a naphthylsulfonyl group, or a 2-pyridylsulfonyl group), an amino group (for example, an amino group, an ethylamino group, a dimethylamino group, a butylaminocarbonyl group, a cyclopentylamino group, a 2-ethylhexylamino group, a dodecylamino group, an anilino group, a naphthylamino group, or a 2-pyridylamino group), a halogen atom (for example, fluorine, chlorine, or bromine), a cyano group, a nitro group, and a hydroxyl group. These substituents may further be substituted by the above-described substituents. A plurality of substituents may also combine with each other to form a ring.

Coumarin dyes are preferred in which in Formula (A), R³⁵ is an amino group or a substituted amino group such as an alkylamino group, a dialkylamino group, an arylamino group, a diarylamino group, or an alkylarylamino group. The coumarin compounds are preferably used in which the alkyl substituent of the substituted amino group in R³⁵ combines with R³⁴ or R³⁶ to form a ring.

Coumarin dyes are more preferred in which in addition to the above, at least one of R³¹ and R³² is an alkyl group (for example, a methyl group, an ethyl group, a propyl group, an isopropyl group, a t-butyl group, a pentyl group, a hexyl group, an octyl group, a dodecyl group, a tridecyl group, a tetradecyl group, or a pentadecyl group), a cycloalkyl group (for example, a cyclopentyl group or a cyclohexyl group), an alkenyl group (for example, a vinyl group or an allyl group), an aryl group (for example, a phenyl group, or a naphthyl group), a heteroaryl group (for example, a furyl group, a thienyl group, a pyridazinyl group, a pyrimidinyl group, a pyrazinyl group, a triazinyl group, an imidazolyl group, a pyrazolyl group, a thiazolyl group, a benzimidazolyl group, a benzoxazolyl group, a quinazolyl group, or a phthalazinyl group), a saturated heterocyclic group (for example, a pyrrolidinyl group, an imidazolidinyl group, a morpholinyl group or an oxazolidinyl group), an alkoxycarbonyl group (for example, a methyloxycarbonyl group, an ethyloxycarbonyl group, a butyloxycarbonyl group, an octyloxycarbonyl group, or a dodecyloxycarbonyl group), an aryloxycarbonyl group (for example, a phenyloxycarbonyl group, or a naphthyloxycarbonyl group), an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecycarbonyl group, a phenylcarbonyl group, a naphthylcarbonyl group, or a pyridylcarbonyl group), an acyloxy group (for example, an acetyloxy group, an ethylcarbonyloxy group, a butylcarbonyloxy group, an octylcarbonyloxy group, a dodecycarbonyloxy group, or a phenylcarbonyloxy group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecyaminocarbonyl group, a phenylaminocarbonyl group, a naphthylaminocarbonyl group, or a 2-pyridylaminocarbonyl group), a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group), an alkylsulfonyl group (for example, a methylsulfonyl group, an ethylsulfonyl group, a butylsulfonyl group, a cyclohexylsulfonyl group, a 2-ethylhexylsulfonyl group, or a dodecylsulfonyl group), an arylsulfonyl group (for example, a phenylsulfonyl group, a naphthylsulfonyl group, or a 2-pyridylsulfonyl group), a halogen atom (for example, fluorine, chlorine, or bromine), a cyano group, a nitro group or a halogenated alkyl group (for example, a trifluoromethyl group, a tribromomethyl group, or a trichloromethyl group).

Preferred examples will be listed below, but the invention is not limited thereto.

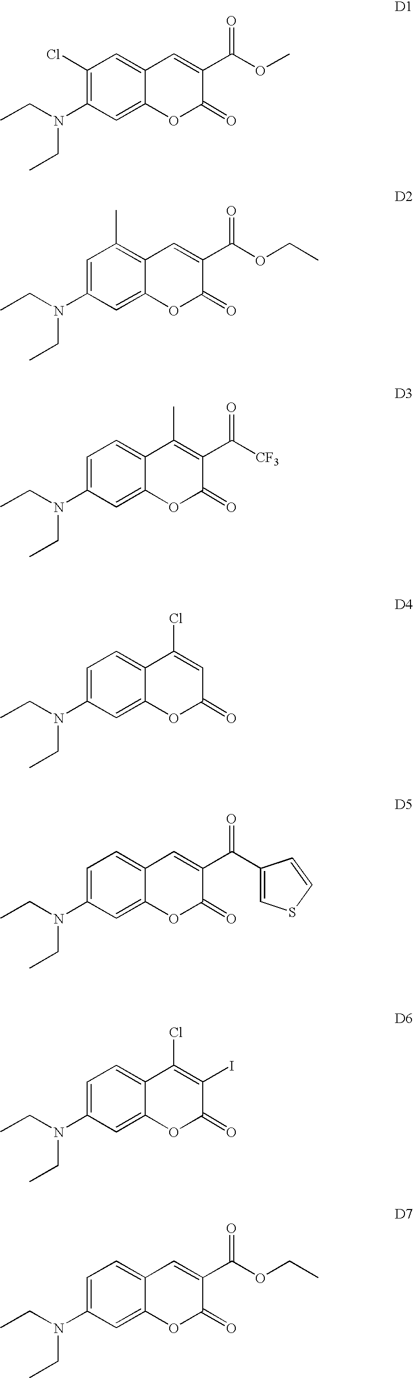

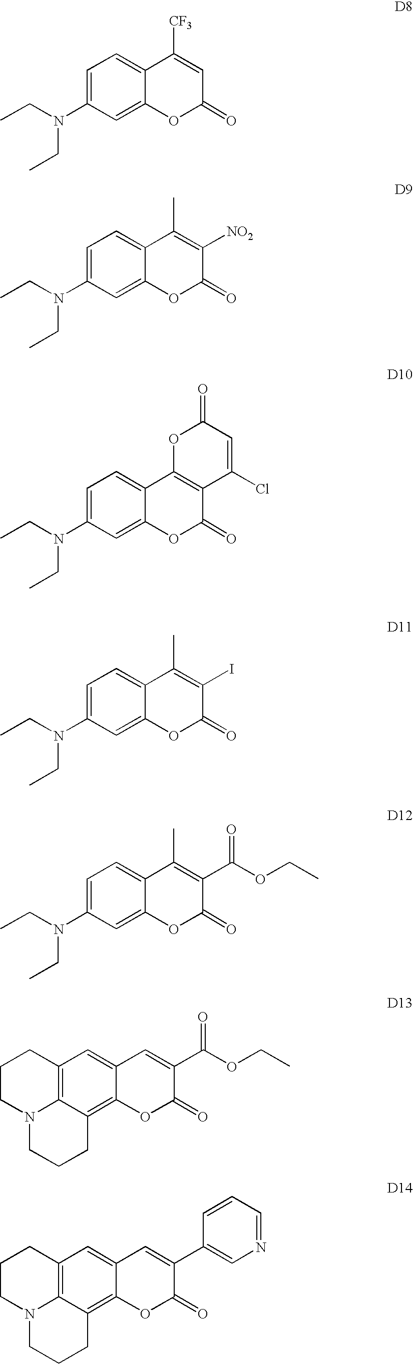

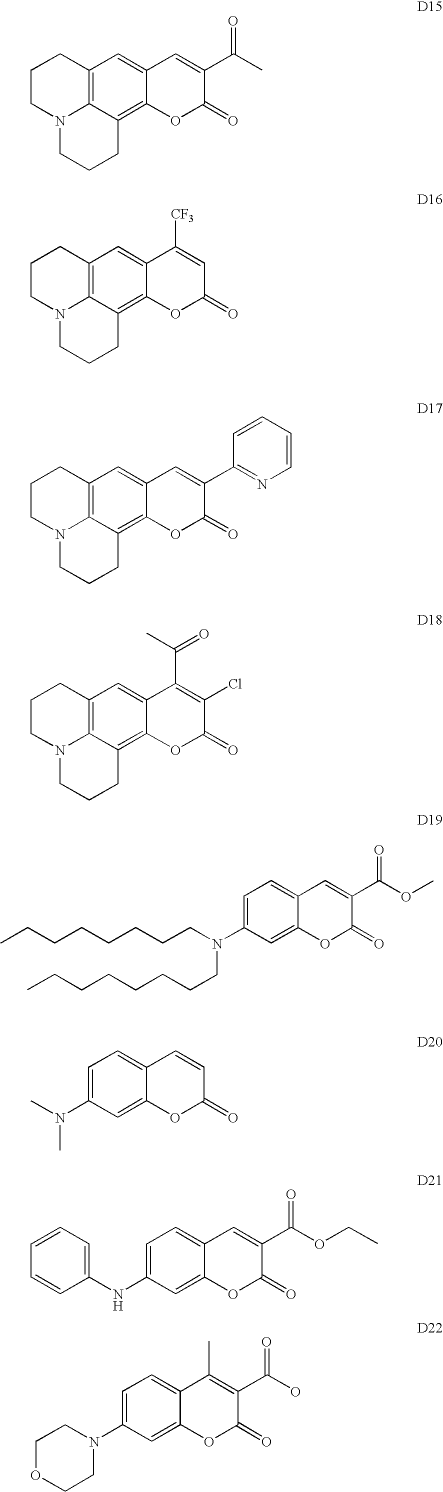

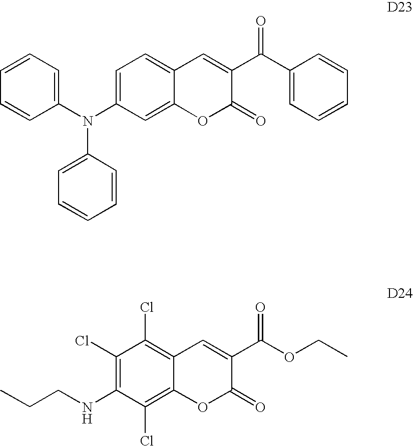

Besides the examples described above, there can be used coumarin derivatives B-1 through B-22 disclosed in Japanese Patent O.P.I. Publication No. 8-129258, coumarin derivatives D-1 through D-32 disclosed in Japanese Patent O.P.I. Publication No. 2003-12901, coumarin derivatives 1 through 21 disclosed in Japanese Patent O.P.I. Publication No. 2002-363206, coumarin derivatives 1 through 40 disclosed in Japanese Patent O.P.I. Publication No. 2002-363207, coumarin derivatives 1 through 34 disclosed in Japanese Patent O.P.I. Publication No. 2002-363208, or coumarin derivatives 1 through 56 disclosed in Japanese Patent O.P.I. Publication No. 2002-363209.

Next, various additives which can be added into the photosensitive composition in the present invention, a support as a photosensitive planographic printing plate, a protective layer, coating of a photosensitive composition onto a support and an image recording method of a photosensitive planographic printing plate will be described below.

### (Various Additives)

The photosensitive layer in the invention is preferably added with a polymerization inhibitor, in order to prevent undesired polymerization of the ethylenically unsaturated compound during the manufacture or after storage of photosensitive planographic printing plate material. Examples of the polymerization inhibitor include hydroquinone, p-methoxyphenol, di-t-butyl-p-cresol, pyrrogallol, t-butylcatechol, benzoquinone, 4,4′-thiobis(3-methyl-6-t-butylphenol), 2,2′-methylenebis(4-methyl-6-t-butylphenol), N-nitrosophenylhydroxylamine cerous salt, and 2-t-butyl-6-(3-t-butyl-2-hydroxy-5-methylbenzyl)-4-methylphenyl acrylate.

The polymerization inhibitor content is preferably 0.01 to 5% by weight based on the total solid content of the photosensitive layer. Further, in order to prevent undesired polymerization induced by oxygen, behenic acid or a higher fatty acid derivative such as behenic amide may be added to the layer. After the photosensitive layer is coated layer, the coated layer may be dried so that the higher fatty acid derivative is localized at the vicinity of the surface of the photosensitive layer. The content of the higher fatty acid derivative is preferably 0.5 to 10% by weight, based on the total solid content of the photosensitive layer.

A colorant can be also used. As the colorant can be used known materials including commercially available materials. Examples of the colorant include those described in revised edition “Ganryo Binran”, edited by Nippon Ganryo Gijutu Kyoukai (published by Seibundou Sinkosha), or “Color Index Binran”. Pigment is preferred.

Kinds of the pigment include black pigment, yellow pigment, red pigment, brown pigment, violet pigment, blue pigment, green pigment, fluorescent pigment, and metal powder pigment. Examples of the pigment include inorganic pigment (such as titanium dioxide, carbon black, graphite, zinc oxide, Prussian blue, cadmium sulfide, iron oxide, or chromate of lead, zinc, barium or calcium); and organic pigment (such as azo pigment, thioindigo pigment, anthraquinone pigment, anthanthrone pigment, triphenedioxazine pigment, vat dye pigment, phthalocyanine pigment or its derivative, or quinacridone pigment).

Among these pigment, pigment is preferably used which does not substantially have absorption in the absorption wavelength regions of a spectral sensitizing dye used according to a laser for exposure. The absorption of the pigment used is not more than 0.05, obtained from the reflection spectrum of the pigment measured employing an integrating sphere and employing light with the wavelength of the laser used. The pigment content is preferably 0.1 to 10% by weight, and more preferably 0.2 to 5% by weight, based on the total solid content of the photopolymerizable photosensitive layer composition.

A purple pigment or a blue pigment is preferably utilized in view of absorption of light with the aforesaid photosensitive wavelength region and image visibility after development. Such pigments include, for example, Cobalt Blue, cerulean blue, Alkali Blue, Phonatone Blue 6G, Victoria Blue Lake, metal-free Phthalocyanine Blue, Phthalocyanine Fast Sky Blue, Indathrene Blue, indigo, Dioxane Violet, Isoviolanthrone Violet, Indanthrone Blue and Indanthrone BC. Among them, more preferable are Phthalocyanine Blue and Dioxane Violet.

The photosensitive layer can contain surfactants as a coating improving agent as long as the performance of the invention is not jeopardized. Among these surfactants, a fluorine-contained surfactant is preferred.

Further, in order to improve physical properties of the cured photosensitive layer, the layer can contain an inorganic filler or a plasticizer such as dioctyl phthalate, dimethyl phthalate or tricresyl phosphate. The content of such a material is preferably at most 10% by weight, based on the total solid content of the photosensitive layer.

The solvents used in the preparation of a photosensitive composition contained in a photopolymerizable photosensitive layer of the present invention include an alcohol such as sec-butanol, isobutanol, n-hexanol, or benzyl alcohol; a polyhydric alcohol such as diethylene glycol, triethylene glycol, tetraethylene glycol, or 1,5-pentanediol; an ether such as propylene glycol monobutyl ether, dipropylene glycol monomethyl ether, or tripropylene glycol monomethyl ether; a ketone or aldehyde such as diacetone alcohol, cyclohexanone, or methyl cyclohexanone; and an ester such as ethyl lactate, butyl lactate, diethyl oxalate, or methyl benzoate.

The photosensitive composition of the present invention has been explained as described above. The photosensitive planographic printing plate was prepared via mixture of each of the above-described compositions being set to the foregoing ratio, and by coating this onto an aluminum support.

### (Protective Layer: Oxygen-Shielding Layer)

A protective layer is preferably provided on the upper surface of a photosensitive layer of the present invention.

### (Protective Layer: Oxygen-Shielding Layer)

It is preferred that the oxygen-shielding layer is highly soluble in a developer described later (generally an alkaline solution). Specific examples thereof include polyvinyl alcohol and polyvinyl pyrrolidone. Polyvinyl alcohol has the effect of inhibiting oxygen permeation, and polyvinyl pyrrolidone also has the effect of acquiring adhesion to an adjacent photosensitive layer.

A photosensitive planographic printing plate material comprising a protective layer containing polyvinyl alcohol as a main component is preferably usable in the present invention.

Examples of water-soluble polymers usable in combination other than the above-described two kinds of polymers, if desired, include polysaccharide, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water-soluble polyamide.

In the planographic printing plate of the present invention, adhesive strength between the protective layer and the photosensitive layer is preferably at least 35 mN/mm, more preferably at least 50 mN/mm, and still more preferably at least 75 mN/mm. Preferred composition of the protective layer is disclosed in Japanese Patent O.P.I. Publication No. 8-161645.

The adhesive strength can be determined according to the following method. The adhesive tape with a sufficient adhesive force is applied on the protective layer, and then peeled together with the protective layer under the applied tape in the normal direction relative to the protective layer surface. Force necessary to peel the tape together with the protective layer is defined as adhesive strength.

The protective layer may further contain a surfactant or a matting agent, if desired. The protective layer is formed, coating on the photopolymerizable photosensitive layer a coating solution in which the above protective layer composition is dissolved in an appropriate coating solvent, and drying. The main solvent of the coating solution is preferably water or an alcohol solvent such as methanol, ethanol, or iso-propanol.

The thickness of the protective layer is preferably 0.1-5.0 μm, and more preferably 0.5-3.0 μm.

### (Support)

The photosensitive composition of the present invention is coated onto a support, whereby a photosensitive planographic printing plate material is constituted. In the A support carrying a hydrophilic surface is employed as a support of the present invention.

A support exhibiting hydrophilicity on its surface, and a support which is subjected to hydrophilic treatment onto its surface are usable as the support carrying a hydrophilic surface.

In the present invention, an aluminum support carrying a hydrophilic surface is preferably used as a support. Both an aluminum support and an aluminum alloy support are allowed to be employed as a support.

As the aluminum alloy, there can be used various ones including an alloy of aluminum and a metal such as silicon, copper, manganese, magnesium, chromium, zinc, lead, bismuth, nickel, titanium, sodium or iron.

The surface of an aluminum support is preferably roughened.

It is preferable that the support is subjected to degreasing treatment for removing rolling oil prior to surface roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting support is preferably subjected to desmut treatment in an aqueous solution of an acid such as phosphoric acid, nitric acid, sulfuric acid, chromic acid, or a mixture thereof, since smut is produced on the surface of the support.

The surface roughening methods include a mechanical surface roughening method and an electrolytic surface roughening method electrolytically etching the support surface.

Employed mechanical surface roughening methods are not particularly limited, but a brush polishing method as well as a honing polishing method is preferred. Surface roughening employing the brush polishing method is, for example, performed as follows. A rotary brush composed of 0.2-0.8 mm brush bristles is pressed, while rotating, onto the surface of a support while feeding, onto the support surface, for example, a slurry which is prepared by uniformly dispersing, into water, 10-100 μm volcanic ash particles. On the other hand, surface roughening employing the honing polishing is, for example, performed in the following manner. Uniformly dispersed into water were 10-100 μm volcanic ash particles, and the resulting dispersion is obliquely ejected and collided onto the surface of the support from a nozzle under pressure, whereby the surface is roughened. Further, for example, the surface of a support is adhered to a sheet on which 10-100 μm abrasive particles are placed at a density of 2.5×10³-10×10³/cm² and an interval of 100-200 μm, and pressure is applied, whereby the surface can be roughened by transferring the rough surface pattern.

After the support has been mechanically surface-roughened, it is preferably dipped in an acid or an aqueous alkali solution in order to remove an abrading agent buried in the support surface, aluminum dust produced on the surface, and so forth. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the support surface is preferably 0.5 to 5 g/m². After the support has been dipped in the aqueous alkali solution, it is preferable for the support to be dipped in an acid such as phosphoric acid, nitric acid, sulfuric acid and chromic acid, or in a mixed acid thereof, for neutralization.

Surface roughening in the present invention may also be performed employing an electrolysis method in which surface roughening is electrochemically achieved in an acidic electrolyte. Surface roughening via electrolysis is performed in an acidic electrolyte such as a hydrochloric acid or nitric acid based solution at a concentration of 0.4-2.8% by weight at an effective current density of 30-100 A/dm² over 10-120 seconds. The concentration of hydrochloric acid or nitric acid is more preferably 1-2.3% by weight. The current density is more preferably 30-80 A/dm², but is still more preferably 40-75 A/dm².

The temperature to conduct the above electrolysis surface roughening method is not particularly limited. However, it is preferable that the above method is employed in the range of 5-80° C., but it is more preferable that the temperature is selected from the range of 10-60° C. The applied voltage is also not particularly limited, and however, the applied voltage is preferably in the range of 1-50 volts but is more preferably in the range of 10-30 volts. The quantity of electricity is also not particularly limited. However, the employed quantity is preferably in the range of 100-5000 c/dm², but is more preferably in the range of 100-2000 c/dm².

Nitrate, chloride, amines, aldehydes, phosphoric acid, chromic acid, boric acid, acetic acid and oxalic acid can be added into an electrolytic solution, if desired.

After surface roughening employing the above electrolysis surface roughening method, it is preferable to immerse the resulting support into an aqueous acid or alkali solution to remove any aluminum waste particles. It is preferable to immerse the resulting support into an aqueous acid or alkali solution. Employed as acids are, for example, sulfuric acid, persulfuric acid, hydrofluoric acid, phosphoric acid, nitric acid, and hydrochloric acid, while employed as alkalis are, for example, sodium hydroxide and potassium hydroxide. The dissolved amount of aluminum on the surface is preferably 0.5-5 g/m². It is preferable that after immersing the support into the aqueous alkali solution, neutralization is performed by immersing the resulting support into phosphoric acid, nitric acid, sulfuric acid, chromic acid, or mixtures thereof.

To conduct an anodizing treatment, an oxidized layer is formed on the support. In the above anodizing treatment, a method is preferably employed in which electrolysis is performed at a current density of 1-10 A/dm², employing as an electrolyte, an aqueous solution containing sulfuric acid or phosphoric acid at a concentration of 10-50%. Other than the above, listed are: the method described in U.S. Pat. No. 1,412,768, in which electrolysis is conducted in sulfuric acid at a higher current density, and the method described in U.S. Pat. No. 3,511,661, in which electrolysis is performed employing phosphoric acid, and a solution containing at least one of chromic acid, oxalic acid, or malonic acid, or a mixture thereof. The anodized coverage amount is commonly 1-50 mg/dm², but is preferably 10-40 mg/dm². The anodized coverage amount is determined in such a manner that an aluminum plate is immersed into a phosphoric acid chromic acid solution (35 ml of a 85% phosphoric acid solution and prepared by dissolving 20 g of chromium (IV) oxide in 1 liter of water) to dissolve the oxidized layer and the weight difference between prior to and after the layer dissolution is recorded.

In the present invention, it is preferable that after anodizing a support surface, the resulting surface is treated with a sodium silicate solution at a temperature of 20-50° C. The above temperature is preferably 20-50° C., but is more preferably 20-45° C. When the temperature is less than 20° C., stain removal occasionally becomes insufficient, while when it exceeds 50° C., plate life tends to be degraded. The concentration of sodium silicate is not particularly limited, but it is preferably 0.01-35%, but is more preferably 0.1-5%.

In the present invention, it is preferable that after the anodizing treatment, the support is treated with a polyvinylphosphonic acid solution at a temperature of 20-70° C. The above temperature is preferably 20-70° C., but is more preferably 30-65° C. When the temperature is less than 20° C., stain removal occasionally becomes insufficient, while when it exceeds 70° C., printing durability tends to be degraded. The concentration of the polyvinylphosphonic acid solution is not particularly limited, but the above concentration is preferably 0.01-35%, but is more preferably 0.1-5%.

### (Coating)

The resulting photosensitive composition (a photopolymerizable photosensitive layer coating solution) is coated on the support according to a conventional method, and dried to obtain a photosensitive planographic printing plate material. Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method.

In the case of low drying temperature for the photosensitive layer, insufficient printing durability results, and in the case of excessively high drying temperature, marangoni, together with fog at the non-image portion is generated. The drying temperature of the coated photosensitive layer is preferably 60-160° C., more preferably 80-140° C., and still more preferably 90-120° C.

### (Image Recording Method)

Laser light having an emission wavelength of 350-450 nm is preferably employed as a light source to record images to a photosensitive planographic printing plate of the present invention.

Examples of such lasers as the light source used for the photosensitive planographic printing plate exposed to light include a He—Cd laser (441 nm), a combination of Cr:LiSAF and SHG crystals (430 nm) as a solid laser, and KnbO₃, ring resonator (430 nm), AlGaInN (350-350 nm) or AlGaInN semiconductor laser (InGaN type semiconductor laser available on the market, 400-410 nm) as a semiconductor type laser.

When a laser is used for exposure, which can be condensed in the beam form, scanning exposure according to an image can be carried out, and direct writing is possible without using any mask material.

When the laser is employed for imagewise exposure, a highly dissolved image can be obtained, since it is easy to condense its exposure spot in minute size.

As laser scanning methods, there are a method of laser scanning on an outer surface of a cylinder, a method of laser scanning on an inner surface of a cylinder and a method of laser scanning on a plane. In the method of laser scanning on an outer surface of a cylinder, laser beam exposure is conducted while a drum around which a recording material is wound is rotated, in which main scanning is represented by the rotation of the drum, while sub-scanning is represented by the movement of the laser beam. In the method of laser scanning on an inner surface of a cylinder, a recording material is fixed on the inner surface of a drum, a laser beam is emitted from the inside, and main scanning is carried out in the circumferential direction by rotating a part of or an entire part of an optical system, while sub-scanning is carried out in the axial direction by moving straight a part of or an entire part of the optical system in parallel with a shaft of the drum. In the method of laser scanning on a plane, main scanning by means of a laser beam is carried out through a combination of a polygon mirror, a galvano mirror and an fθ lens, and sub-scanning is carried out moving a recording medium. The cylinder outer surface laser scanning method and the cylinder inner surface laser scanning method are suitable for high density image recording, since it is easier to increase accuracy of an optical system. The cylinder outer surface laser scanning method is especially preferred in employing laser energy effectively, and in designing easily the optical system including the laser used.

In the present invention, imagewise exposure is carried out at a plate surface energy (an exposure energy at the surface of the planographic printing plate material) of 10-500 mJ/cm², and more preferably 10-300 mJ/cm². This exposure energy can be measured, employing a laser power meter PDGDO-3W produced by Ophir Optronics Inc.

### (Developer)

The image-recorded photosensitive layer is cured at the portion exposed to light. The portion unexposed to light is removed by developing this with an alkaline developer to form images. A commonly known alkaline aqueous solution is usable as such the developer. Examples of the alkaline developer utilizing an inorganic alkali agent include sodium silicate, potassium silicate, ammonium silicate, sodium secondary phosphate, potassium secondary phosphate, ammonium secondary phosphate, sodium bicarbonate, potassium bicarbonate, ammonium bicarbonate, sodium carbonate, potassium carbonate, ammonium carbonate, sodium hydrogencarbonate, potassium hydrogencarbonate, ammonium hydrogencarbonate, sodium borate, potassium borate, ammonium borate, sodium hydroxide, potassium hydroxide, ammonium hydroxide, lithium hydroxide and so forth.

Further, utilized can be organic alkali agents such as monomethylamine, dimethylamine, trimethylamine, monoethylamine, diethylamine, triethylamine, mono-i-propylamine, di-i-propylamine, tri-i-propylamine, butylamine, monoethanolamine, diethanolamine, triethanolamine, mono-i-propanolamine, di-i-propanolamine, ethyleneimine, ethylenediamine and pyridine.

These alkali agents are used singly or in combination. an anionic surfactant, an amphoteric surfactant or organic solvents such as alcohol and so forth can also be added into the developer, if desired, but specifically, a developer containing an anionic surfactant is preferably usable.

### (Other Additives)

The developer may contain the following additives in order to increase development performance. Examples of the additives include a neutral salt such as sodium chloride, potassium chloride, potassium bromide, as disclosed in Japanese Patent O.P.I. Publication No. 58-75152, a complex such as [Co(NH₃)₆]Cl₃ as disclosed in Japanese Patent O.P.I. Publication No. 59-121336, an amphoteric polymer such as a copolymer of vinylbenzyl-trimethylammonium chloride and sodium acrylate as disclosed in Japanese Patent O.P.I. Publication No. 56-142258, the organic metal containing surfactant containing Si or Ti as disclosed in Japanese Patent O.P.I. Publication No. 59-75255, and the organic boron containing compound disclosed in Japanese Patent O.P.I. Publication No. 59-84241.

A photosensitive planographic printing plate material of the present invention is imagewise-exposed to laser light having an emission wavelength in a wavelength region of 350-450 nm, and is preferably developed employing an alkaline developer containing an anionic surfactant with a pH of 11-12.6.

### (Automatic Developing Machine)

It is advantageous that an automatic developing machine is used in order to develop a photosensitive planographic printing plate material. It is preferred that the automatic developing machine is equipped with a means for replenishing a developer replenisher in a necessary amount, a means for discharging any excessive developer and a means for automatically replenishing water in necessary amounts which is attached to the development section. It is preferred that the automatic developing machine comprises a means for detecting a transported planographic printing plate precursor, a means for calculating the area of the planographic printing plate precursor based on the detection, or a means for controlling the replenishing amount of a developer replenisher, the replenishing amount of water to be replenished, or the replenishing timing. It is also preferred that the automatic developing machine comprises a means for detecting a pH, temperature and/or electric conductivity of a developer, or a means for controlling the replenishing amount of the developer replenisher, the replenishing amount of water to be replenished or the replenishing timing, based on the detection. It is also preferred to provide a mechanism of diluting the developer concentrate with water and of stirring the diluted concentrate. Where the developing step is followed by a washing step, washing water used for washing can be reused as dilution water for diluting the developer concentrate.

The automatic developing machine used in the present invention may be provided with a pre-processing section to allow the plate to be immersed in a pre-processing solution prior to development. The pre-processing section is provided preferably with a mechanism of spraying a pre-processing solution onto the plate surface, preferably with a mechanism of controlling the pre-processing solution at a temperature within the range 25-55° C., and preferably with a mechanism of rubbing the plate surface with a roller-type brush. Common water and the like are employed as the pre-processing solution.

### (Post-Processing)

The planographic printing plate developed with a developer having the composition is preferably subjected to post-processing. The post-processing step comprises post-processing the developed precursor with a post-processing solution such as washing water, a rinsing solution containing a surfactant, a finisher or a protective gumming solution containing gum arabic or starch derivatives as a main component. The post-processing step is carried out employing an appropriate combination of the post-processing solution described above. For example, a method is preferred in which a developed planographic printing plate precursor is post-washed with washing water, and then processed with a rinsing solution containing a surfactant, or a developed planographic printing plate precursor is post-washed with washing water, and then processed with a finisher, since it reduces fatigue of the rinsing solution or the finisher. It is preferred that a multi-step countercurrent processing is carried out employing a rinsing solution or a finisher.

The post-processing is carried out employing an automatic developing machine having a development section and a post-processing section. In the post-processing step, the developed printing plate is sprayed with the post-processing solution from a spray nozzle or is immersed into the post-processing solution in a post-processing tank. A method is known in which supplies a small amount of water onto the developed printing plate precursor to wash the precursor, and reuses the water used for washing as dilution water for developer concentrate. In the automatic developing machine, a method is applied in which each processing solution is replenished with the respective processing replenisher according to the area of the printing plate precursor to have been processed or the operating time of the machine. A method (so-called use-and-discard method) can be applied in which the developed printing plate material is processed with fresh processing solution and discarded. The thus obtained planographic printing plate is mounted on a printing press, and printing is carried out.

### EXAMPLE

Next, the present invention will be explained below employing examples, but the present invention is not limited thereto. In the examples, “parts” represents “parts by weight”, unless otherwise specified.

A 0.3 mm thick aluminum plate (material 1050, refining H16) was degreased at 65° C. for one minute in a 5% by weight sodium hydroxide aqueous solution, washed with water, immersed at 25° C. for one minute in a 10% by weight hydrochloric acid aqueous solution to neutralize, and then washed with water.

The resulting aluminum plate was electrolytically roughened in a 0.3% by weight nitric acid aqueous solution using an alternating current at 25° C. for 60 seconds at a current density of 100 A/dm², and was subsequently desmutted in a 5% by weight sodium hydroxide aqueous solution maintained at 60° C. for 10 seconds. The desmutted aluminum plate was anodized in a 15% sulfuric acid solution at 25° C. for one minute at a current density of 10 A/dm² and at a voltage of 15 V, and was subjected to a hydrophilization treatment with 3% by weight of polyvinyl phosphonic acid at 75° C. to prepare a support.

The center line average surface roughness (Ra) of the support was 0.65 μm.

### (Binder)

### Acrylic Resin (PA-1)

A solution containing a methacrylic acid/methyl methacrylate/ethyl methacrylate copolymer (15:30:55 in weight ratio of methacrylic acid/methyl methacrylate/ethyl methacrylate:Tg: 101° C., acid value: 98 mg of KOH, and molecular weight (Mw): 35000) in 20.0% by weight of 2-butanone.

### (Preparation of Photosensitive Planographic Printing Plate Material 1)

A photopolymerizable photosensitive layer coating solution shown in the following Table was coated on the foregoing support employing a wire bar so as to give a dry thickness of 1.6 g/m², and was dried at 90° C. for 2 minutes. Next, an oxygen-shielding layer coating solution having the following composition was coated on a photosensitive layer employing an applicator so as to give a dry thickness of 1.8 g/m², and was dried at 75° C. for 1.5 minutes to prepare photosensitive planographic printing plate material 1 comprising an oxygen-shielding layer provided on a photosensitive layer.

### (Photopolymerizable Photosensitive Layer Coating Solution 1)

TABLE 1

| | Addition amount |
|---|---|
| Material | (Parts by weight) |
| Monomer compound No. 1 | 26.0 |
| Binder 2; foregoing PA-1 (20% by weight | 136.4 |
| solution) | |
| Sensitizing dye; D-1 shown below | 3.8 |
| Initiator; I-1 shown below | 3.7 |
| Hydrogen-donating compound; C-1 shown | 0.3 |
| below | |
| 35% by weight MEK dispersion (MHI #454, | 6 |
| produced by Mikuni Color Ltd.) | |
| Surfactant EDUPLAN LA-411 (produced by | 0.1 |
| Münzing Chemie GmbH) | |
| Solution 1; | 113.7 |
| Methylethylketone | |
| Solution 2; | 717 |
| Propileneglycolmonomethylether | |

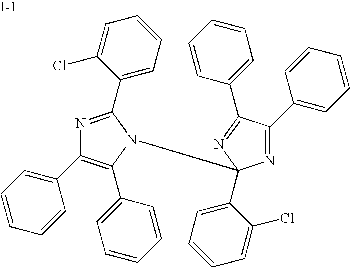

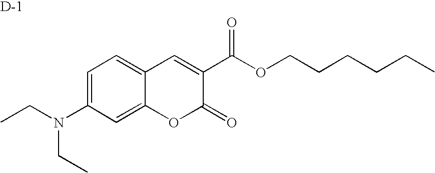

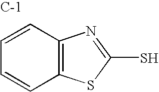

### (Oxygen-Shielding Layer Coating Solution 1)

| | |
|---|---|
| Polyvinyl alcohol (AL-06, produced | 89.5 parts |
| by Nippon Gosei Kagaku Co., Ltd.) | |
| Polyvinyl pyrrolidone (Luvitec, produced by BASF) | 10.0 parts |
| Surfactant (Surfinol 465, produced by | 0.5 parts |
| Nisshin Kagaku Kogyo Co., Ltd.) | |
| Water | 900 parts |

### (Image Formation and Development Treatment)

The resulting photosensitive planographic printing plate material 1 was imagewise exposed at an exposure of 50 μJ/cm² and a resolving degree of 2400 dpi (herein, dpi represents the number of dots per 2.54 cm) so as to make an area ratio between an image portion and a non-image portion to be 1:9, employing a plate setter (MAKO4, produced by ECRM Co, Ltd.) equipped with laser of 60 mW as a light source. The image pattern used for the exposure comprised a solid image and a square dot image with a screen number of 175 LPI and each of a 98% dot area, a 96% dot area, a 94% dot area, a 92% dot area, a 90% dot area, an 85% dot area, an 80% dot area, a 75% dot area, a 70% dot area, a 60% dot area, a 50% dot area, a 40% dot area, a 30% dot area, a 20% dot area, a 15% dot area, a 10% dot area, an 8% dot area, a 6% dot area, a 5% dot area, a 4% dot area, a 3% dot area, a 2% dot area, and a 1% dot area.

Subsequently, the exposed sample was subjected to development treatment employing a CTP automatic developing machine PHW32-V (manufactured by Technigraph Corp.) fitted with a preheating section for preheating to a printing plate temperature of 105-130° C., a pre-washing section for removing the oxygen-shielding layer before development, a development section charged with developer having the following developer composition, a washing section for removing the developer remaining on the printing plate surface, a gumming solution for protecting an image portion (a solution obtained by diluting GW-3 produced by Mitsubishi Chemical Co., Ltd., with water by a factor of 2), while supplying a replenisher solution at a rate of 50 ml/m² to obtain a planographic printing plate. Preheating was carried out at a surface temperature of 110° C. during printing. Contact time between the photosensitive planographic printing plate and the developer is designated as development time, and the development time consumed with the above-described automatic developing machine is 25 seconds.

A developer having the following composition was prepared.

| | |
|---|---|
| The following compound P-1 | 3.0% by weight |
| Chelate agent (Dissolvin Na2-S, | 0.5% by weight |
| produced by Akzo Nobel K.K.) | |
| Potassium hydroxide | Addition amount to make pH 12.1 |

### The remaining component is water.

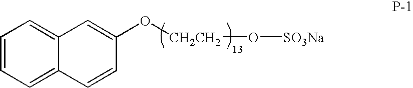

Photosensitive planographic printing plate materials 2-37 were prepared similarly to preparation of photosensitive planographic printing plate material 1, except that monomer was replaced by compound Nos. 2-37.

### (Linearity Evaluation)

Dots of a planographic printing plate obtained via the foregoing development were measured employing X-riteDot (manufactured by X-rite).

The dot area at shadow portions is easy to be deteriorated when a halftone dot area ratio after development becomes extremely larger than an exposure area, whereby the adjustment during plate making and printing becomes difficult. Since no small dot also tends to be made when the halftone dot area ratio becomes smaller than the exposure area, the dot area is desired to be larger than the exposure area for the dot reproduction, and the nearer to the exposure area the dot area is, the better dot reproduction.

A: A halftone dot area ratio of the 50% dot area being at least 50% and less than 60%.

B: A halftone dot area ratio of the 50% dot area being at least 60% and less than 68%.

C: A halftone dot area ratio of the 50% dot area being less than 50%, as well as a halftone dot area ratio of the 50% dot area being at least 68%

### (Evaluation of Resistance to Chemicals)

Employing the resulting planographic printing plate sample after the foregoing development, printing was carried out on a press (DAIYA1F-1 produced by Mitsubishi Heavy Industries, Ltd.), wherein coated paper, printing ink (Soybean oil ink, “Naturalith 100” produced by Dainippon Ink Kagaku Co., Ltd.), and dampening water (SG-51, H solution produced by Tokyo Ink Co., Ltd., Concentration: 1.5%) were used. The image surface was wiped every 500 prints for one minute with a PS sponge impregnated with an ultra-plate cleaner, the lack situation of the 3% dot area in prints was observed with a loupe, and the number of sheets printed when a half of the 3% dot area lacks was defined as a measure of resistance to chemicals. The more the printed sheets are, the superior the resistance to chemicals.

### (Printing Performance—Evaluation of Stain at Non-Image Portion)

Employing the resulting printing plate sample after the development, printing was carried out on a press (DAIYA1F-1 produced by Mitsubishi Heavy Industries, Ltd.), wherein coated paper, printing ink (Soybean oil ink, “Naturalith 100” produced by Dainippon Ink Kagaku Co., Ltd.), and dampening water (SG-51, H solution produced by Tokyo Ink Co., Ltd., Concentration: 1.5%) were used. A non-image portion of ten thousandth copy was observed visually or with a loupe, and the number of small stain spots was confirmed and evaluated according to the following criteria as a measure of printing performance.

A least 3 small stain spots having a size of at least 100 μm observed in a region of 10 cm×10 cm were evaluated “C” as an inappropriate print.

Zero to two small stain spots having a size of at least 100 μm observed in a region of 10 cm×10 cm were evaluated “B” as a usable print. No small stain spot which was observed was evaluated “A” as an excellent print.

### (Evaluation of Safe Light Property)

Immediately after the resulting photosensitive material was exposed to light of 240 l× combining a fluorescent lamp F40W/35 (produced by General Electric Company) with V50 (produced by Encapslite) at 23° C. and 50% RH with changing of the exposure time, an imagewise exposure at 50 μJ/cm² with a resolving degree of 2400 dpi (herein, dpi represents the number of dots per 2.54 cm) was conducted. The image pattern used for the exposure comprised a solid image and a square dot image with a screen number of 175 LPI and each of a 98% dot area, a 96% dot area, a 94% dot area, a 92% dot area, a 90% dot area, an 85% dot area, an 80% dot area, a 75% dot area, a 70% dot area, a 60% dot area, a 50% dot area, a 40% dot area, a 30% dot area, a 20% dot area, a 15% dot area, a 10% dot area, an 8% dot area, a 6% dot area, a 5% dot area, a 4% dot area, a 3% dot area, a 2% dot area, and a 1% dot area. Dot % of the 50% dot area in an image of the resulting planographic printing plate sample was measured employing a dot area measuring apparatus (X-riteDot model: CCD5, produced by Centurfax Ltd).

Based on a sample which is not exposed to safe light, the maximum time capable of maintaining a dot variation within ±2%, based on the sample, was defined as permitted time of safe light.

Photosensitive planographic printing plate material 38 was prepared similarly to preparation of photosensitive planographic printing plate material 1, except that the initiator of photosensitive planographic printing plate material 3 was replaced by the following I-2.

Photosensitive planographic printing plate material 39 was prepared similarly to preparation of photosensitive planographic printing plate material 1, except that the initiator of photosensitive planographic printing plate material 3 was replaced by the following I-3.

The above-described evaluation results are shown in the following tables. As is clear from the following Table 2 and Table 3, it is to be understood that the photosensitive planographic printing plate material of the present invention exhibits excellent resistance to chemicals and printing performance, together with an excellent safe light property.

TABLE 2

| Photo sensitive | | | | Stain at | |
|---|---|---|---|---|---|
| planographic | Linearity 50% | Linearity | | non-image | |
| printing plate | halftone dot | evaluation | | portion | |
| material No. | area ratio (%) | (Rank) | *1 | (Rank) | Remarks |
| 1 | 58 | A | 50 | A | Inv. |
| 2 | 58 | A | 60 | A | Inv. |
| 3 | 58 | A | 60 | A | Inv. |
| 4 | 56 | A | 60 | A | Inv. |
| 5 | 66 | B | 60 | A | Inv. |
| 6 | 67 | B | 60 | A | Inv. |
| 7 | 65 | B | 60 | A | Inv. |
| 8 | 58 | A | 50 | A | Inv. |
| 9 | 62 | B | 55 | A | Inv. |
| 10 | 63 | B | 55 | A | Inv. |
| 11 | 64 | B | 55 | A | Inv. |
| 12 | 64 | B | 55 | A | Inv. |
| 13 | 63 | B | 55 | A | Inv. |
| 14 | 65 | B | 55 | A | Inv. |
| 15 | 66 | B | 55 | A | Inv. |
| 16 | 60 | B | 55 | A | Inv. |
| 17 | 59 | B | 60 | A | Inv. |
| 18 | 56 | A | 60 | A | Inv. |
| 19 | 57 | A | 55 | A | Inv. |
| 20 | 56 | A | 55 | A | Inv. |
| 21 | 57 | A | 55 | A | Inv. |
| 22 | 65 | B | 55 | A | Inv. |
| 23 | 63 | B | 55 | A | Inv. |
| 24 | 68 | B | 50 | A | Inv. |
| 25 | 68 | B | 50 | A | Inv. |
| 26 | 66 | B | 50 | A | Inv. |
| 27 | 62 | B | 55 | A | Inv. |
| 28 | 57 | A | 60 | A | Inv. |
| 29 | 58 | A | 60 | A | Inv. |
| 30 | 59 | B | 55 | A | Inv. |
| 31 | 66 | B | 60 | A | Inv. |
| 32 | 67 | B | 60 | A | Inv. |
| 33 | 66 | B | 60 | A | Inv. |
| 34 | 68 | B | 60 | A | Inv. |
| 35 | 75 | C | 40 | C | Comp. |
| 36 | 78 | C | 45 | C | Comp. |
| 37 | 40 | C | 5 | A | Comp. |

*1: Evaluation of resistance to chemicals (Number of copies)
Inv.: Present invention,
Comp.: Comparative example

TABLE 3

| | | Evaluation of | | |
|---|---|---|---|---|
| Photosensitive | | resistance to | Stain at | |
| planographic | Safe light | chemicals | non-image | |
| printing plate | property | (Number of | portion | |
| material No. | (minutes) | copies) | (Rank) | Remarks |
| 3 | 40 | 60 | A | Inv. |
| 36 | 20 | 45 | C | Comp. |
| 37 | 60 | 5 | A | Comp. |
| 38 | 5 | 10 | B | Comp. |
| 39 | 3 | 15 | C | Comp. |

Inv.: Present invention,
Comp.: Comparative example

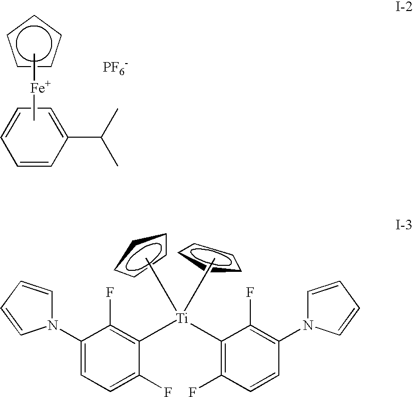

| Compound No. | Q | R | R₁ | R₂ | a | X₁ | X₂ | k | b | R₃ | n |
|---|---|---|---|---|---|---|---|---|---|---|---|
| 35 | 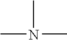 | CH₃(CH₂)₃— | H | H | 1 | *—(CH₂)₆—* | —CH₂CH₂— | 2 | 1 | CH₃ | 2 |
| 36 | 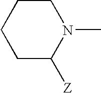 | — | H | H | 0 | *—(CH₂)₆—* | —CH₂CH₂— | 2 | 1 | CH₃ | 1 |
| 37 | — | —CH₂CH(C₂H₅)(CH₃)CH₂— | — | — | 0 | *—(CH₂)₆—* | —CH₂CH₂— | — | 1 | CH₃ | 2 |

### EFFECT OF THE INVENTION

Utilizing the foregoing structures, provided can be a photosensitive planographic printing plate material, a photosensitive composition for the photosensitive planographic printing plate material, and a method of recording the planographic printing plate material which are suitable for exposure employing laser light having an emission wavelength of 350-450 nm, and exhibit excellent resistance to chemicals and excellent linearity, together with an excellent safe light property.

What is claimed is:

1. A photosensitive composition comprising:
(A) an addition-polymerizable ethylenic double bond-containing compound that is represented by the following Formula (1);
(B) a biimidazole compound that acts as a photopolymerization initiator;
(C) a polymer binder; and
(D) a dye exhibiting an absorption maximum wavelength of 350-450 nm.
R₍ₘ₋ₙ₎Q[(CH₂C(R₁)(R₂)O)ₐCONH(X₁NHCOO)_{b}X₂(OOCC(R₃)═CH₂)_{C}]ₙ Formula (1)
where R represents an alkyl group, a hydroxyalkyl group or an aryl group; R₁ and R₂ each represent a hydrogen atom, an alkyl group or an alkoxyalkyl group; R₃ represents a hydrogen atom, a methyl group or an ethyl group; X₁ represents an aromatic hydrocarbon group having 6-24 carbon atoms or an alkyl group containing an aromatic hydrocarbon group having 6-24 carbon atoms; X₂ represents a saturated hydrocarbon group having 2-8 carbon atoms; Q represents 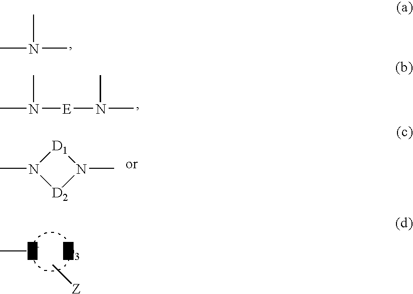
; D₁ and D₂ represent a saturated hydrocarbon group having 1-12 carbon atoms; D₃ represents a saturated hydrocarbon group having 4-8 carbon atoms that forms a 5- to 6-member ring with a nitrogen atom; E represents a saturated hydrocarbon group having 1-12 carbon atoms; Z represents a hydrogen atom, a saturated hydrocarbon group having 1-3 carbon atoms or a —CₖH₂ₖO—CONH(X₁—NHCOO)_{b}—X₂(—OOC—C(R₃)═CH₂) group; a is an integer of 0-4; b is 0 or 1; k is an integer of 1-12; m is 2, 3 or 4; n is an integer of 1-m; and c is 1 or 2.

2. The photosensitive composition of claim 1, further comprising a hydrogen-donating compound.

3. The photosensitive composition of claim 2,
wherein the hydrogen-donating compound is a sulfur-containing compound.

4. A photosensitive planographic printing plate material comprising a support and provided thereon, a photosensitive layer comprising the photosensitive composition of claim 1.

5. A method of recording the photosensitive planographic printing plate material of claim 4, comprising the step of:
exposing the photosensitive planographic printing plate material to laser light having an emission wavelength of 350-450 nm as a recording light source to record an image.
